(19) United States
(12) Patent Application Publication
(10) Pub. No.: US 2006/0039847 A1
(43) Pub. Date: Feb. 23, 2006

(54) Low pressure ammonia synthesis utilizing adsorptive enhancement

(75) Inventors: Wayne Scott Kaboord, Oregon, WI (US); Dawn Marie Becher, Random Lake, WI (US); Fred Joseph Begale, Oconomowoc, WI (US); Daniel Woodrow Fellers, Milwaukee, WI (US); Steven M. Kuznicki, Edmonton (CA)

Correspondence Address: PAUL V. KELLER, LLC, 4585 LIBERTY RD., SOUTH EUCLID, OH, 44121, US

(73) Assignee: Eaton Corporation, Cleveland, OH (US)

(21) Appl. No.: 10/924,050

(22) Filed: Aug. 23, 2004

(51) Int. Cl. C01C 1/04

(52) U.S. Cl. 423/359; 422/148

(57) ABSTRACT

One aspect of the invention relates to a process for synthesizing ammonia from hydrogen and nitrogen in which an adsorbant is provided to adsorb ammonia as it is being produced. Adsorption of the product drives the ammonia synthesis reaction and allows the process to be carried out at pressures where the gas phase equilibrium conversion is too low for a conventional system to be practical. The invention is applicable to both small and large scale ammonia synthesis. A small scale ammonia synthesis plant can be a stationary or vehicle-mounted plant used to supply reducing agent for selective catalytic reduction of NOx in diesel exhaust. Ammonia can be desorbed from the adsorbant, extracted from the adsorbant, or stored and transported in its adsorbed state.

### FIELD OF THE INVENTION

The present invention relates to a process for manufacturing ammonia from nitrogen and hydrogen.

### BACKGROUND OF THE INVENTION

Ammonia synthesis from hydrogen and nitrogen is an industrially important process. Many researches have studied this process searching for improvements. Improvements have been made, particularly with respect to catalysts, but the basic process, known as the Haber process, has remained unchanged since its development almost one hundred years ago.

The Haber process is based on the reaction: 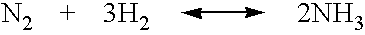
This reaction is reversible, meaning both the forward and reverse reactions proceed at appreciable rates under typical reaction conditions. Lowering the temperature shifts the equilibrium in favor ammonia production, but lowering the temperature also lowers the reaction rate. Catalysts accelerate the reaction, but even with catalysts the reaction rate places a lower limit on the practical temperature range. Increasing the pressure also shift the equilibrium in favor of ammonia production, but increasing the pressure increases both pumping costs and equipment costs.

A typical industrial process involves a compromise in both temperature and pressure. For example, a typical process is carried out at about 500° C. and 250 atm over an iron catalyst. At these conditions, the reaction equilibrium limits the single pass conversion to about 20%. The overall conversion is increased by separating the product from the reactor exhaust and recirculating the unconverted reagents.

A typical separation process involves cooling the exhaust to condense ammonia and then physically separating the liquid ammonia. Other separation processes have been mentioned. U.S. Pat. No. 4,180,553 proposes recovering hydrogen by membrane separation. U.S. Pat. No. 1,219,663 describes separating ammonia by adsorption onto carbon or absorption into a liquid. U.S. Pat. No. 4,537,760 describes an adsorptive separation process in which a hot stream of ammonia-containing gases is used to regenerate the adsorbant followed by condensation of ammonia from the gases.

There remains a long felt need for an improved ammonia synthesis process.

### SUMMARY OF THE INVENTION

The following presents a simplified summary in order to provide a basic understanding of some aspects of the invention. This summary is not an extensive overview of the invention. The primary purpose of this summary is to present some concepts of the invention in a simplified form as a prelude to the more detailed description that is presented later.

One aspect of the invention relates to a process for synthesizing ammonia from hydrogen and nitrogen in which an adsorbant is provided to adsorb ammonia as it is being produced. Adsorption of the product drives the ammonia synthesis reaction and allows the process to be carried out at pressures where the gas phase equilibrium conversion is too low for a conventional system to be practical.

The invention is applicable to both small and large scale ammonia synthesis. A small scale ammonia synthesis plant can be a stationary or vehicle-mounted plant used to supply reducing agent for selective catalytic reduction of NOx in diesel exhaust. Ammonia can be desorbed from the adsorbant, extracted from the adsorbant, or stored and transported in its adsorbed state.

To the accomplishment of the foregoing and related ends, the following description and annexed drawings set forth in detail certain illustrative aspects and implementations of the invention. These are indicative of but a few of the various ways in which the principles of the invention may be employed. Other aspects, advantages and novel features of the invention will become apparent from the following detailed description of the invention when considered in conjunction with the drawings.

### BRIEF DESCRIPTION OF THE DRAWINGS

FIG. 1 is schematic illustration of an ammonia synthesis plant according to one aspect of the invention;

FIG. 2 is an illustration of an ammonia synthesis reactor according to another aspect of the invention;

FIG. 3 is an illustration of the reactor of FIG. 2 in a second configuration;

FIG. 4 is a schematic illustration of an ammonia synthesis reactor according to a further aspect of the invention;

FIG. 5 is an illustration of an ammonia synthesis reactor according to a still further aspect of the invention;

FIG. 6 is an illustration of the reactor of FIG. 5 during adsorbant regeneration;

FIG. 7 is a schematic illustration of an ammonia plant comprising a plurality of batch ammonia synthesis reactors;

FIG. 8 is a schematic illustration of an ammonia synthesis reactor according to another aspect of the invention.

### DETAILED DESCRIPTION OF THE INVENTION

FIG. 1 is a schematic illustration of an exemplary ammonia synthesis plant 100 according to one aspect of the present invention. The ammonia synthesis plant 100 comprises a hydrogen source 101, a nitrogen source 102, and three reaction vessels A 103, B 104, and C 105. The three reaction vessels each contain an adsorbant for ammonia. Generally, at least one of the reaction vessels is generating ammonia while at least one other of the vessels is undergoing adsorbant regeneration. An ammonia plant according to the invention can have greater or fewer reaction vessels that the plant 100.

In an exemplary process according to the invention, one or more of the three vessel 103-105 is supplied with hydrogen from the hydrogen source 101 and nitrogen from the nitrogen source 102, generally in a 3:1 molar ratio. The hydrogen and nitrogen react in the vessel to produce ammonia. The ammonia adsorbs onto the adsorbant, reducing the concentration of ammonia in the gas and driving the reaction forward.

The reaction is driven forward in accordance with Le Chatelier's principle. Le Chatelier's principle states that when a system at equilibrium is subject to a change, the system will respond to relieve the effect of that change. In this case, the system is the gas phase and the change is removal of ammonia from the gas phase by capturing ammonia on the adsorbant. This tends to reduce the gas phase ammonia concentration. The system responds by producing more ammonia, which tends to maintain the ammonia concentration. The overall effect is that system produces more ammonia than it would in the absence of the adsorbant.

Hydrogen and nitrogen are supplied in an amount that is generally limited by the capacity of the adsorbant. The hydrogen and nitrogen can be supplied at once at the beginning of the reaction, can be supplied continuously as the reaction progresses, or anywhere in between. Where inert contaminants reach substantial concentrations, it may be desirable to vent a small amount of gas from the reactor to keep the concentration of the inerts from becoming too high.

The reaction can be carried out at comparatively low pressures. In one embodiment, the reaction vessel is at pressure of about 50 bar or less, in another embodiment, about 25 bar or less, in a further embodiment, about 10 bar or less, and in a still further embodiment, at about atmospheric pressure. At low pressures, the gas phase equilibrium of the reaction of hydrogen and nitrogen to form ammonia is relatively low. According to the invention, however, ammonia is selectively adsorbed from the gas onto the adsorbant. This reduces the availability of ammonia for the reverse reaction and allows the net conversion of ammonia to proceed beyond that which would result in gas phase equilibrium in the absence of an adsorbant. In one embodiment, the single pass conversion is at least about two times the gas phase equilibrium conversion.

Preferably, the net conversion of reagents fed to the vessel reaches at least about 35%, more preferably at least about 50%, still more preferably at least about 75%, and most preferably at least about 90%. These are single pass conversion rates, which are calculated based on feed rates, whereby reagents removed from the vessel and then recirculated back into the vessel would be counted twice. According to the invention, such recirculation is generally not necessary. If the reagents are not fed in stoichiometric proportions, the conversion rate is based on the limiting reagent. The ammonia substantially remains in an adsorbed state unless and until the adsorbant is regenerated. The net adsorption of ammonia onto the adsorbant over the course of the ammonia synthesis is comparable to the net rate of ammonia generation.

In certain applications, the final product is the ammonia in an adsorbed state. This is particularly useful when the ammonia is used to supply a reducing agent for selective catalytic reduction (SCR) of NOx in exhaust. SCR reduces ammonia even in a lean atmosphere. While this is a promising approach to meeting NOx emission-limiting regulations for cars and trucks, distribution and supply of ammonia is a major obstacle. The invention provides a way of overcoming this obstacle. The ammonia can be produced in small plants, which can either be vehicle-mounted or stationary. Stationary plants can be small and low cost, installed for example at fuel stations. The adsorbed state provides a safe an efficient way of storing and transporting ammonia. The ammonia can be desorbed as needed, by heating the adsorbant, for example. If the ammonia decomposes into hydrogen and nitrogen when it is heated and desorbed, this is not necessarily an issue in that SCR may proceed effectively with hydrogen in place of ammonia.

In other applications however, it is desirable to recover the ammonia from the adsorbant and regenerate the adsorbant without having the ammonia decompose into hydrogen and nitrogen. Ammonia can be recovered and the adsorbant regeneration by desorbing the ammonia or extracting it. Extraction can be, for example, with water. Desorption can proceed by any suitable method, including reducing the ammonia partial pressure and/or increasing the temperature. Ammonia partial pressure can be lowered by lowering the total pressure and/or using an inert carrier to dilute the ammonia in the gas phase. An inert carrier could be N₂, which may be flowed over the adsorbant to reduce the ammonia partial pressure and carry away desorbed ammonia. In one embodiment, a N₂ carrier is used together with heating. Desorbed ammonia can be captured by any suitable method, including for example adsorption on a solid adsorbant, adsorption by a liquid (extraction), or condensation. Desorbed ammonia can be stored as a compressed gas or liquid. A liquid can be an aqueous solution.

Where ammonia is desorbed by increasing the adsorbant temperature, there is a concern that the ammonia synthesis reaction may reverse. Generally, the reaction will begin to reverse in the absence of a catalyst at temperatures above 450° C. Preferably, desorption takes place at temperatures of about 450° C. or less. There are two general approaches to synthesizing and adsorbing ammonia according to the invention and desorbing the ammonia at an elevated temperature without the synthesis reaction being reversed. One approach is to create a temperature gradient within the reaction vessel during ammonia synthesis whereby the ammonia is adsorbed at a temperature below that at which it is produced. The other is to provide a catalyst which contacts the ammonia during synthesis but not during regeneration. These two approaches can be combined.

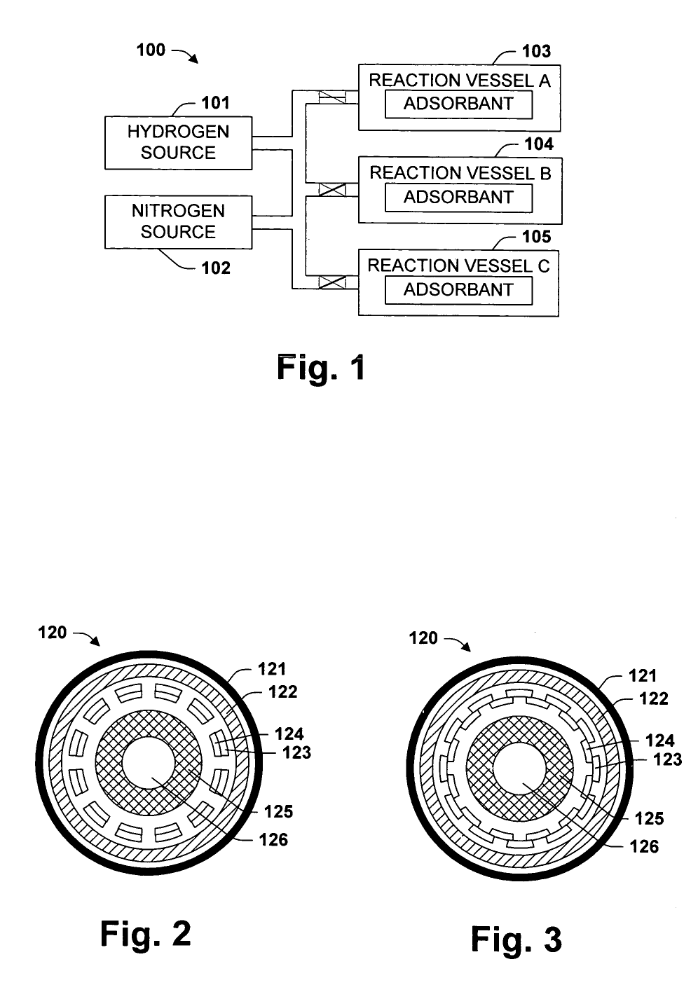

FIGS. 2 and 3 are illustrations of an ammonia synthesis reactor 120 according to one embodiment of the present invention in which the catalyst is selectively isolated from the adsorbant by a mobile barrier. The ammonia synthesis reactor 120 comprises a shell 121, a catalyst 122, a first slotted barrier 123, a second slotted barrier 124, and an adsorbant 125. The second slotted barrier 124 is movable between a first position shown in FIG. 2 and a second position shown in FIG. 3. In the first position, the slots line up and gases freely move between the catalyst 122 and the adsorbant 125. In the second position the slots do not line up and the catalyst 122 is effectively isolated from the adsorbant 125.

The first position, with the slots aligned, is for ammonia generation. Reaction takes place on the catalyst 122 and drives the concentration of ammonia in the gas phase towards an equilibrium at the temperature of the catalyst 122 and the prevailing pressure. Adsorption of ammonia on the adsorbant 125 steadily removes ammonia from the gas phase. Thus, ammonia is simultaneously produced on the catalyst 122 and adsorbed on the adsorbant 125.

Ammonia migrates from the catalyst 122 to the adsorbant 125 without pumping. A fan can be provided to increase the circulation rate, but is generally unnecessary. The flow of gases entering the reactor 120 can also be used to induce circulation, however, there is essentially no pressure gradient between the catalyst 122 and the adsorbant 125. Strictly speaking, small pressure gradients exist due to such phenomena as the adsorption of ammonia, the flow of reagents into the vessel, temperature gradients, and the change in number of moles due to reaction, however, the pressure gradients created by these phenomena are negligible in comparison to the vessel pressure, which is preferably essentially uniform at any given time during the course of the ammonia synthesis in the reactor 120.

In this example, there is generally a significant temperature gradient between the catalyst 122 and the adsorbant 125. This gradient can be used to advantage. A gradient naturally arises because the ammonia synthesis reaction is exothermic. Adsorption is also generally exothermic, but usually much less so than is the reaction. Furthermore, the catalyst and any support is generally less massive than the adsorbant and any support. Preferably, a temperature gradient of at least about 75° C. develops between the catalyst 122 and the adsorbant 125 during ammonia synthesis, more preferably at least about 100° C., and still more preferably at least about 125° C.

The temperature gradient can be further enhanced by heating the catalyst and/or cooling the adsorbent. Generally, heating the catalyst is unnecessary and undesirable, except perhaps to initiate the synthesis process. Ample heat is generated by the reaction. Higher temperatures give higher reaction rates, but also a lower maximum gas phase ammonia concentration. Excessively high catalyst temperatures may also result in catalyst degradation. The catalyst may need to be cooled, but preferably the catalyst loses sufficient heat to the adsorbant to maintain the catalyst temperature within an acceptable range without any additional cooling.

Where the adsorbant is cooled during synthesis, it is generally cooled by heat exchange with a cooling fluid. One or more passages can be provided through the adsorbant for thermal contacting with a cooling agent. The reactor 120 has a central passage 126 adapted to either heat or cool the adsorbant 125. The adsorbant 125, can be cooled for example by passing ambient air through the central passage. This same passage can be used later to heat the adsorbant. For example, the adsorbant can be heated by passing hot exhaust through the central passage. An adsorbant can also be provided with an electrical resistance heater.

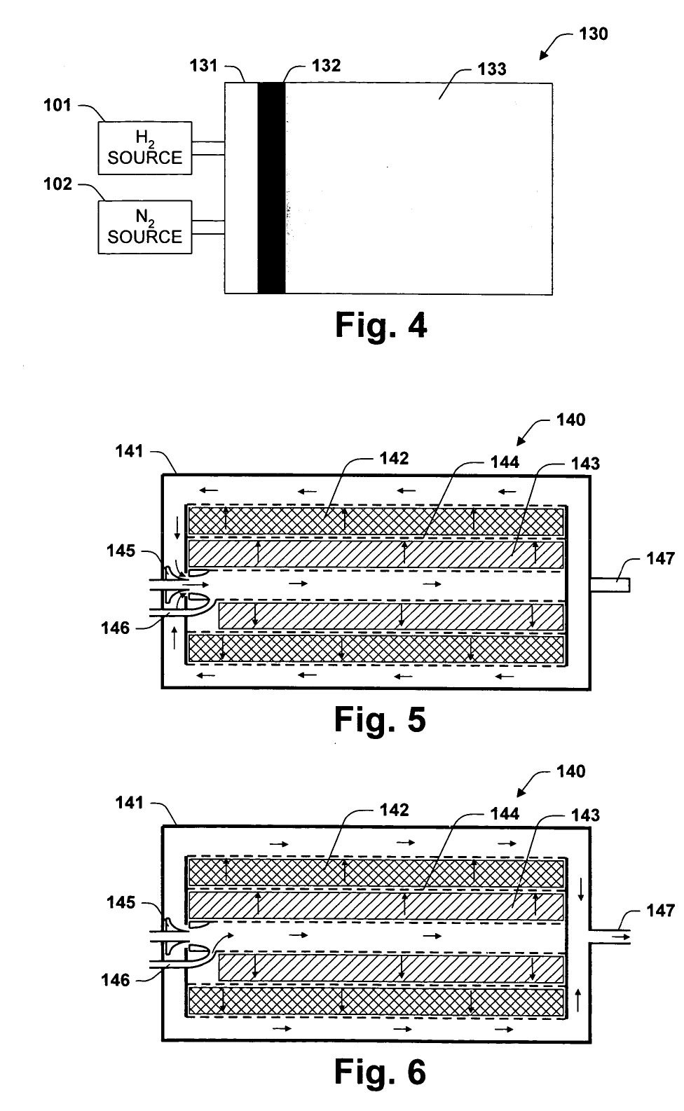

FIG. 4 illustrates a reactor 130 in which a temperature gradient can be created without providing for fluid isolation between the adsorbant and the catalyst and even when the adsorbant and catalyst are combined. The reactor 130 comprises the hydrogen source 101, the nitrogen source 102, and a reaction vessel 131, containing an adsorber/catalyst 133. Hydrogen and nitrogen enter through one end of the vessel 131 and react primarily within a small reaction zone 132.

Optionally, the vessel is first charged with nitrogen. Optionally, the reaction zone is pre-heated, for example with electrical wires. The hydrogen entering the vessel encounters the reaction zone 132 and reacts with nitrogen to produce ammonia and heat. Whether or not the reaction zone 132 is pre-heated, it tends to experience a greater reaction rate due to the higher concentration of reagents and becomes hotter than the rest of the adsorber/catalyst 133. The higher reaction rate means greater heat release, further increasing the reaction rate and further enhancing the temperature difference. Optionally, the catalyst is provided only in the reaction zone 132. Optionally, insulation or a physical break is provided to reduce the conduction of heat between the reaction zone 132 and the rest of the adsorber/catalyst 133.

The ammonia produced in the reaction zone 132 diffuses through the adsorber/catalyst 133 and is adsorbed until the adsorbant becomes saturated. Once synthesis is complete, the reaction zone 132 can be allowed to cool. The adsorber/catalyst 133 can then be heated to desorb ammonia without reaching the temperatures prevailing the reaction zone 132 during ammonia synthesis.

FIGS. 5 and 6 are schematic illustration of a reactor 140 in which a plug flow condition is used to keep the ammonia from the catalyst during regeneration. The reactor 140 comprises a shell 141, an adsorbant 142, and a catalyst 143. A porous barrier 144 separates the adsorbant 142 from the catalyst 143. During ammonia generation, feed gases are supplied through a throttle valve 145. The flow of feed gases through the throttle valve 145 induces recirculation of gases between the catalyst 143 and the adsorbant 142. A temperature gradient may develop between the adsorbant 142 and the catalyst 143, but is not required. The reaction is carried out at a first temperature, for example from about 300 to about 350° C.

During regeneration, nitrogen is fed through feed tube 146, an exhaust valve 147 is open, and there is essentially no recirculation of gas between the catalyst 143 and the adsorbant 142. The nitrogen serves both to reduces the partial pressure of ammonia in the reactor and to carry the ammonia away from the catalyst 143. The nitrogen can further be used to heat the reactor. During regeneration, the reactor temperature is generally raised, for example to a temperature from about 400 to about 450° C. The reactor produces a dilute ammonia stream, for example, having an ammonia concentration from about 5 to about 15%. A stream at this concentration can be used directly for SCR of NOx.

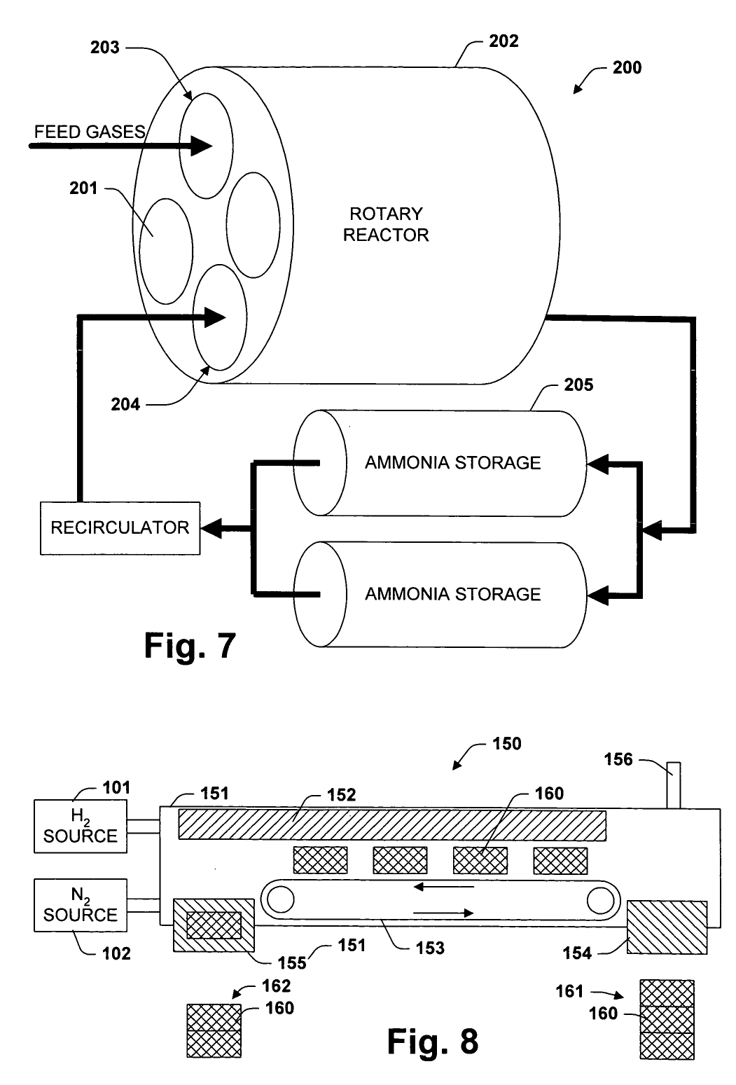

FIG. 7 illustrates an ammonia synthesis plant 200 for continuously producing ammonia with a group of batch reactors 201. The batch reactors 201 could follow the design of the reactor 140 or another of the reactors described herein. The batch reactors 201 are arranged in a mobile framework 202. The mobile framework 202 alternately places each reactor 201 in a position 203 to receive feed gases and generate ammonia and in a position 204 to undergo regeneration with a recirculating carrier gas. The carrier gas is preferably nitrogen. The mobile framework 202 can move the reactors 201 in any suitable manner. In the present example, the mobile framework 202 rotates to change the reactor positions. The mobile framework 202 may provide a plurality of positions for either ammonia generation or for adsorbant regeneration. Additional positions may be devoted to heating or cooling the reactors 201, where appropriate. The recirculating gas carries desorbed ammonia from the reactors 201 to one or more ammonia storage devices 205. The ammonia storage devices 205 can separate the ammonia from the carrier gas by any suitable means, for example, adsorbing the ammonia at a temperature lower than the temperature of the reactors 201. The recirculator 206 can be any device that drives the flow of the recirculating gas, for example, a fan or a compressor.

FIG. 8 is a schematic illustration of a reactor 150 also designed for continuous production of ammonia. The reactor 150 comprise a shell 151 and a catalyst 152. Adsorbant bricks 160 from stack 161 enter the reactor 150 through an entry air lock 154, are carried through the reactor 150 by the conveyor 153, and exit the reactor through exit air lock 154. As the bricks move through the reactor, they adsorb ammonia and drive an ammonia synthesis reaction.

The ammonia synthesis reaction takes place over the catalyst 152. Hydrogen is supplied by a hydrogen source 151 and nitrogen from a nitrogen source 152. The reagents are supplied stoichimetrically, or with a slight excess of hydrogen. Excess nitrogen and/or accumulated inerts can be vented through port 156. Preferably, a substantial gradient in the hydrogen concentration develops over the length of the reactor.

The reactor 150 can operate with a substantial temperature gradient between the adsorbant bricks 160 and the catalyst 152. The ammonia synthesis reaction heats the catalyst 152. The bricks 160 can be relatively cool when they enter the reactor 150. The bricks 160 draw heat from the reactor 150 and may advantageously cool the catalyst 152, however, the bricks can perform this function without rising to the catalyst temperature. If the ammonia is adsorbed by the bricks at a low enough temperature, the ammonia can be recovered by heating the bricks without any substantial breakdown of ammonia. Optionally, energy to heat the bricks during regeneration can be drawn from the catalyst 152, whereby the energy requirements for the entire process can be kept minimal.

The reaction vessels of the present invention all contain an adsorbant. The adsorbant is generally distributed throughout the bulk of the vessel, whereby even when a catalyst is used the majority of the ammonia production takes place in close proximity to the adsorbant, for example, which about one meter, more preferably within about 10 cm. Likewise, the majority of the void volume of the vessel is generally in close proximity to the adsorbant.

The hydrogen source 101 can be any suitable hydrogen source. Suitable hydrogen sources include tanks, electrolysis devices, and fuel reformers. A fuel reformer can be a catalytic reformer, a steam reformer, an autothermal reformer, or a plasma reformer and is optionally mounted on a vehicle. A reformer converts fuel, such as diesel, gasoline, propane, methane, or natural gas into synthesis gas (syn gas). Relatively pure hydrogen can be extracted from syn gas by any suitable method, for example, temperature or pressure swing adsorption.

The nitrogen source 102 can be any suitable source of relatively pure nitrogen. The nitrogen source is often a membrane separator, although pressure and temperature swing adsorption systems can also be used to obtain relatively pure nitrogen from air. Typically, a membrane separator will admit argon, which can accumulate in the reaction vessel. Such accumulation is limited by venting a small amount of gas with a high argon concentration.

Preferably, a reactor according to the present invention operates at or below a pressure at which nitrogen is recovered from air or at which hydrogen is recovered from syn gas, whereby the reagent can be supplied to the reactor without further compression.

Any suitable adsorbant material can be used. Examples of adsorbants are molecular sieves, such as zeolites, alumina, silica, and activated carbon. Further examples are oxides, carbonates, and hydroxides of alkaline earth metals such as Mg, Ca, Sr, and Be or alkali metals such as K or Ce. Still further examples include metal phosphates, such as phosphates of titanium and zirconium.

Molecular sieves are materials having a crystalline structure that defines internal cavities and interconnecting pores of regular size. Zeolites are the most common example. Zeolites have crystalline structures generally based on atoms tetrahedrally bonded to each other with oxygen bridges. The atoms are most commonly aluminum and silicon (giving aluminosilicates), but P, Ga, Ge, B, Be, and other atoms can also make up the tetrahedral framework. The properties of a zeolite may be modified by ion exchange, for example with a rare earth metal or chromium. While the selection of an adsorbant depends on such factors as the desired adsorption temperature and desorption method, preferred zeolites for ammonia storage generally include faujasites, rare earth zeolites, and Chabazite. Faujasites include X and Y-type zeolites. Rare earth zeolites are zeolites that have been extensively (i.e., at least about 50%) or fully ion exchanged with a rare earth metal, such as lanthanum. A Chabazite is preferably a calcium Chabazite. A Chabazite can be cation exchanged with lithium to improve adsorption capacity.

The adsorbant is typically combined with a binder and either formed into a self-supporting structure or applied as a coating over an inert substrate. A binder can be, for example, a clay, a silicate, or a cement. Generally, the adsorbant is most effective when a minimum of binder is used. Preferably, the adsorbant bed contains from about 3 to about 20% binder, more preferably from about 3 to about 12%, most preferably from about 3 to about 8%. A preferred composition for small adsorbant pellets that can be used to form monoliths, larger pellets, or a porous coatings over an inert substrate such as screening, is molecular sieve crystals with about 8% or less portland cement as a binder. This composition can provide structural integrity and high utilization of the molecular sieve's adsorption capacity.

A catalyst is not necessarily required and in some cases, the adsorbant acts as a catalyst, particularly where the adsorbant is a zeolite. Where a catalyst is used, it can be any suitable catalyst for the reaction of hydrogen and nitrogen to produce ammonia. Typical catalysts include iron, which may be promoted with oxides of one or more of aluminum, magnesium, calcium, and potassium. Other catalysts include Group VIII metal compounds such as ruthenium, optionally combined an alkali metal and a Ba compound, molybdenum oxycarbonitride, and nickel-molybdenum. Combinations of a Group VIII metals and Group VIB metals in the nitride form can also be employed. Still further catalyst are described in the literature and are available commercially. The catalyst may be combined with a binder.

For mobile applications, adsorbants and catalyst are either formed into a self-supporting structures or applied as a coating over inert substrates. Mobile applications create restrictions on weight, dimensions, and durability for adsorbant and catalyst beds. For example, an adsorption or catalyst bed for a vehicle exhaust systems must be reasonably resistant to degradation under the vibrations encountered during vehicle operation.

Beds that have an adsorbant function tend to be large in comparison to beds that have only a catalytic function. To limit the total mass and thermal inertia, an adsorbant bed preferably comprises a high loading of adsorbant per unit bed mass. Preferably, an adsorbant bed comprises at least about 40% adsorbant by weight. The weight of an adsorbant bed includes any inert substrate and any binders, but does not include any housing. Preferably an adsorbant bed comprises at least about 20% adsorbant by volume.

Adsorbant and catalyst beds are optionally provided with mechanisms for heating and/or cooling. For example, a bed can be permeated with heat-exchange passages in fluid isolation from the passages provided for adsorption or catalysis. A hot or cold fluid is circulated through the heat-exchange passages to heat or cool the bed. A cooling fluid could be, for example, engine coolant or ambient air. A heating fluid could be, for example, hot exhaust or a fluid that draws heat from hot exhaust or a heat-producing device such as an ammonia synthesis reactor, a fuel reformer, or an adsorber. Another option is electrical resistance heating. Where a bed includes a metal substrate, the metal substrate can be used as an electrical resistance heater. A bed can also be permeated by wires for electrical resistance heating.

An adsorbant or catalyst bed can have any suitable structure. Examples of suitable structures may include monoliths, packed beds, and layer screening. A packed bed for a mobile application is preferably formed into a cohesive mass by sintering the particles or adhering them with a binder. When the bed has an adsorbant function, preferably any thick walls, large particles, or thick coatings have a macro-porous structure facilitating access to micro-pores where adsorption occurs. A macro-porous structure can be developed by forming the walls, particles, or coatings from small particles of adsorbant sintered together or held together with a binder.

Preferably an NH₃ adsorption bed has a large capacity for adsorbing a NH₃ species at a typical adsorption temperature NH₃ partial pressure. Preferably, the adsorbant can adsorb at least about 3% NH₃ by weight adsorbant at a typical adsorption temperature and 1 atm NH₃ partial pressure, more preferably at least about 5% by weight adsorbant, and still more preferably at least about 7% by weight adsorbant. The weight of adsorbant does not include the weight of any binders or inert substrates.

The invention has been shown and described with respect to certain aspects, examples, and embodiments. While a particular feature of the invention may have been disclosed with respect to only one of several aspects, examples, or embodiments, the feature may be combined with one or more other features of the other aspects, examples, or embodiments as may be advantageous for any given or particular application.

1. A process for synthesizing ammonia, comprising:
providing a vessel containing an adsorbant that adsorbs ammonia in preference to H₂ and N₂; and
bringing H₂ and N₂ together in the vessel under conditions where the H₂ and the N₂ react at a rate sufficient to bring about significant conversion to ammonia within the vessel;
wherein ammonia is adsorbed by the adsorbant simultaneously with the reaction and the adsorbant captures ammonia and thereby enhances the net conversion of H₂ and N₂ to ammonia.

2. The process of claim 1, wherein the single pass conversion rate for H₂ and N₂ through the vessel is at least about 50%.

3. The process of claim 1, wherein the conversion of H₂ and N₂ to ammonia is at least twice the equilibrium conversion in the absence of adsorbant at the temperature and pressure of the adsorbant.

4. The process of claim 1, where the vessel is maintained at a pressure of about 50 atm or less.

5. The process of claim 4, where the vessel is maintained at a pressure of about 10 atm or less.

6. The process of claim 1, wherein the vessel contains a catalyst for the reaction of H₂ and N₂ to produce ammonia and the catalyst is physically combined with the adsorbant.

7. The process of claim 6, wherein the adsorbant is the catalyst.

8. A batch ammonia synthesis process according to claim 1.

9. A vessel, an adsorbant, a nitrogen source, and a hydrogen source collectively configured to carrying out a process according to claim 1.

10. The process of claim 1, wherein the adsorbant is a molecular sieve.

11. The process of claim 10, wherein the adsorbant is a zeolite selected from the group consisting of Chabazite, faujasite, and rare earth zeolites.

12. The process of claim 11, wherein the adsorbant comprises an effective amount of Chabazite cation exchanged with lithium.

13. The process of claim 1, wherein the bulk of the reaction occurs within one meter of the adsorbant.

14. The process of claim 1, further comprising regenerating the adsorbant by heating.

15. The process of claim 1, wherein bringing H₂ and N₂ together in the vessel under conditions where the H₂ and the N₂ react comprises introducing H₂ and N₂ into vessel while at least a portion of the adsorbant is at a temperature greater than that of the combined H₂ and N₂, whereby the adsorbant heats the H₂ and N₂ to a temperature at which the reaction occurs.

16. The process of claim 1, wherein the nitrogen is obtained by membrane separation from air and the nitrogen is supplied from the membrane separation process to the vessel without increasing the nitrogen pressure.

17. The process of claim 1, further comprising providing an ammonia synthesis catalyst in the vessel, wherein the ammonia synthesis catalyst is physically separate from the adsorbant, but there is no substantial pressure gradient between the catalyst and the adsorbant during reaction and adsorption.

18. The process of claim 17, wherein there is a substantial temperature gradient between the catalyst and the adsorbant during reaction and adsorption.

19. The process of claim 18, wherein the temperature gradient is at least about 75° C.

20. The process of claim 1, wherein the adsorbant is at a temperature from about 100 to about 350° C.

21. The process of claim 20, wherein the adsorbant is at a temperature of at least about 200° C.

22. The process of claim 1, further comprising replacement of the adsorbant prior to regeneration of the adsorbant, wherein the vessel is not used to synthesize ammonia during replacement of the adsorbant.

23. The process of claim 1, further comprising regeneration of the adsorbant, wherein the vessel is not used to synthesize ammonia during regeneration of the adsorbant.

24. The process of claim 1, wherein the process is carried out without appreciable heat exchange between the vessel or any of its contents and any cooling fluid external to the vessel.

25. A process using ammonia, comprising:
synthesizing ammonia according to the process of claim 1; and
using the ammonia in the process without condensing the ammonia to liquid form between the synthesis and the use.

26. The process of claim 1, further comprising a regeneration step in which the adsorbant is heated to desorb the ammonia.

27. The process of claim 26, wherein heating the adsorbant comprises heating to a temperature above the temperature condition at which the ammonia formed.

28. The process of claim 1, wherein the adsorbant is in the form of multiple units that are cycled through the vessel as the ammonia-forming reaction takes place.

29. The process of claim 1 wherein the H₂ and or N₂ are injected into the vessel at a high velocity to cause circulation within the vessel.

30. The process of claim 1, further comprising a regeneration step in which nitrogen is flowed through the vessel and carries away ammonia desorbed from the adsorbant.

31. An ammonia synthesis plant, comprising:
a reaction vessel containing an adsorbant for ammonia.
a nitrogen source configured to supply the reaction vessel with nitrogen; and
a hydrogen source configured to supply the reaction vessel with hydrogen;
wherein the reaction vessel is configured to bring about reaction of the hydrogen and the nitrogen to produce ammonia and the adsorbant is configured to adsorb the ammonia.

32. The ammonia synthesis plant of claim 31, wherein the plant is not configured to recirculate unreacted nitrogen and hydrogen exiting the vessel.

33. The ammonia synthesis plant of claim 31, wherein the adsorbant is distributed whereby the majority of void volume within the vessel is within 1 meter of the adsorbant.

34. The ammonia synthesis plant of claim 31, wherein the plant is configured to provide a single-pass conversion rate for the ammonia synthesis reaction of at least about 50%.

35. The ammonia synthesis plant of claim 31, wherein the plant is configured to provide a single-pass conversion rate for the ammonia synthesis reaction of at least twice the equilibrium conversion in the absence of the adsorbant.

36. The ammonia synthesis plant of claim 31, wherein the vessel is configured to operate at a pressure of about 50 atm or less.

37. The ammonia synthesis plant of claim 36, wherein the vessel is configured to operate at a pressure of about 10 atm or less.

38. The ammonia synthesis plant of claim 31, wherein the vessel contains a catalyst for the reaction of H₂ and N₂ to produce ammonia and the catalyst is physically combined with the adsorbant.

39. The ammonia synthesis plant of claim 38, wherein the adsorbant is the catalyst.

40. The ammonia synthesis plant of claim 31, wherein the plant is configured for batch operation.

41. The ammonia synthesis plant of claim 40, wherein the plant comprises multiple reaction vessels.

42. The ammonia synthesis plant of claim 31, wherein the adsorbant is a molecular sieve.

43. The ammonia synthesis plant of claim 42, wherein the adsorbant is a zeolite selected from the group consisting of Chabazite, faujasite, and rare earth zeolites.

44. The ammonia synthesis plant of claim 43, wherein the adsorbant comprises an effective amount of Chabazite cation exchanged with lithium.

45. The ammonia synthesis plant of claim 31, wherein the plant is configured to bring abut the reaction and the adsorption at substantially the same pressure.

46. The ammonia synthesis plant of claim 31, wherein the plant is configured to regenerate the adsorbant by heating.

47. The ammonia synthesis plant of claim 31, wherein the nitrogen source is an apparatus for membrane separation of nitrogen from air and the plant is configured to supply the nitrogen to the vessel without increasing the nitrogen pressure.

48. The ammonia synthesis plant of claim 31, wherein:
the reaction vessel comprises an ammonia synthesis catalyst physically separate from the adsorbant; and
the plant is configured whereby there is no substantial pressure gradient between the catalyst and the adsorbant during reaction and adsorption.

49. The ammonia synthesis plant of claim 48, wherein the plant is configured to develop a substantial temperature gradient between the catalyst and the adsorbant during reaction and adsorption.

50. The ammonia synthesis plant of claim 49, wherein the temperature gradient is at least about 75° C.

51. The ammonia synthesis plant of claim 31, wherein the reaction vessel does not include a heat exchanger.

52. An ammonia synthesis plant according to claim 31 adapted for mounting on a vehicle.

53. An ammonia synthesis plant according to claim 31, wherein plant is configure to move the adsorbant through the reaction vessel as the ammonia-forming reaction takes place.

54. An ammonia synthesis plant according to claim 31, wherein the plant is configured to inject H₂ and or N₂ into the vessel at a high velocity to cause circulation within the vessel.

55. A method of enhancing the single pass conversion in an ammonia synthesis plant comprising:
placing an ammonia adsorbant inside the plant to adsorb ammonia as it is produced; and
intermittently inducing desorption from the adsorbant to regenerate the adsorbant.

56. The method of claim 55, wherein the adsorbant is Chabazite cation exchanged with lithium.

57. The method of claim 55, wherein inducing desorption comprises heating the adsorbant.

58. The method of claim 55, wherein inducing desorption comprises flowing N₂ over the adsobant.

59. A process of separating gaseous ammonia from other gasses, comprising:
adsorbing the ammonia on an adsorbant comprising an effective amount of Chabazite cation exchanged with lithium; and
inducing desorption of the ammonia.

60. The method of claim 59, wherein inducing desorption comprises heating the adsorbant.

61. An ammonia synthesis plant, comprising:
a plurality of ammonia synthesis reactors comprising an adsorbant that adsorbs ammonia synthesized in the reactors;
a mobile framework configured to hold the reactors and move them in sequence through a plurality of positions; and
one or more couplings adapted to provide a feed comprising hydrogen and nitrogen to the reactors in a subset of the positions;
wherein a subset is at least one, but less than all;
whereby the mobile framework is adapted to move the reactors in and out of position to receive the feed and at any given time less than all of the reactors are configured to receive the feed.

62. The ammonia synthesis plant of claim 61, wherein the mobile framework holds the plurality of reactors in a radial array and the mobile framework moves the reactors by rotating the array.

63. The ammonia synthesis plant of claim 61, further comprising:
a coupling adapted to receive an inert gas;
wherein the mobile framework is designed to alternately place each of the reactors into position to receive the inert gas and the ammonia synthesis plant is desgined to recirculate the inert gas to induce desorption of ammonia.

64. A method of synthesizing ammonia, comprising:
providing a plurality of ammonia synthesis reactors comprising an adsorbant for ammonia; and
providing an indexing system that moves the reactors whereby each of the reactors alternates through a set of positions and in one or more of the positions the reactors receive a feed comprising hydrogen and nitrogen in one or more others of the positions the reactors receive a flow of inert gas;
wherein the feed reacts in the reactors to produce ammonia that adsorbs on the adsorbant; and
the ammonia desorbs and is carried away by the flow of inert gas, whereby the adsorbant is regenerated.
